(19) United States
(12) Patent Application Publication
(10) Pub. No.: US 2024/0256983 A1
(43) Pub. Date: Aug. 1, 2024

(54) SYSTEM AND METHOD FOR MANAGING LATENT BIAS IN SUPPORT VECTOR MACHINES

(71) Applicant: Dell Products L.P., Round Rock, TX (US)

(72) Inventors: OFIR EZRIELEV, Be'er Sheva (IL); TOMER KUSHNIR, Omer (IL); FATEMEH AZMANDIAN, Raynham, MA (US)

(21) Appl. No.: 18/160,587

(22) Filed: Jan. 27, 2023

(51) Int. Cl. G06N 20/10; G06N 5/04

(52) U.S. Cl. CPC G06N 20/10; G06N 5/04

(57) ABSTRACT

Methods, systems, and devices for providing computer implemented services are disclosed. To provide the computer implemented services, inference models may generate and provide inferences used in the computer implemented services. The inference models may be obtained through training using training data. Training processes used to train the inference models may proactively to attempt to reduce the likelihood of the trained inference models exhibiting latent bias. The training process may disincentivize predictive power with respect to bias features and incentivize predictive power for labels through use of debiasing terms.

### FIELD

Embodiments disclosed herein relate generally to managing inference models. More particularly, embodiments disclosed herein relate to systems and methods to manage latent bias in support vector machine based inference models.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIG. 2A shows a diagram of training data in accordance with an embodiment.

FIGS. 2B-2E shows diagrams illustrating use of support vector machine based inference models in accordance with an embodiment.

FIGS. 3A-3B show flow diagrams illustrating methods for providing computer implemented services using tree based models in accordance with an embodiment.

FIG. 4 shows a diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for providing computer implemented services. The computer implemented services may be provided using inferences obtained from inference models.

The quality of the computer implemented services may depend on the quality of the inferences provided by the inference models. The quality of the inferences provided by the inference models may depend on the source of, type of, and/or quantity of training data used to obtain the inference models, the manner in which inference models are configured using the training data, and/or other factors.

Latent bias may be introduced into inference models from training data used to train the inference models. The latent bias may cause the inference models to exhibit latent bias in the inferences provided by the inference models. These inferences may cause undesirable impacts on the computer implemented services performed using such inferences.

To reduce latent bias exhibited inference models, a training procedure may be implemented that takes into account the potential for trained inference models to exhibit latent bias. The training process may proactively attempt to reduce the likelihood of trained models exhibiting latent bias.

The inference models may be implemented using support vector machine (SVM) based models, and the training procedure may utilize a debiasing term when selecting a decision boundary for the SVM based models. By training the SVM based models using a debiasing term, the resulting trained inference models may be less likely to exhibit latent bias with respect to the bias features. For example, decision boundaries for the SVMs may be likely to classify records into groups reflecting labels, but the group members may not reflect bias features. For example, the members of each group of classified records may be associated with a near uniform distribution of the bias features.

Once obtained, the inference models may be used to generate inferences. The inferences may be used to provide the computer implemented services. Accordingly, by providing inferences models that are less likely to exhibit latent bias in generated inferences, the computer implemented services may be more likely to be provided in a desirable manner. Thus, embodiments disclosed herein may address, among others, the technical problem of latent bias exhibited by inference models. By training inferences models as disclosed herein, resulting inference models may be less likely to exhibit latent bias.

In an embodiment, a method for providing computer implemented services using inference models is provided. The method may include identifying an occurrence of a condition that indicates an inference is necessary to provide the computer implemented services; based on the occurrence: obtaining an inference model of the inference models, the inference model being a support vector machine based inference model that is based on a soft margin and a debiasing term; obtaining the inference using the inference model; and providing the computer implemented services using the inference.

Obtaining the inference model may include reading the inference model from storage.

Obtaining the inference model may include, prior to identifying the occurrence: training an instance of the support vector machine based inference model using training data.

The training data may include records, and each of the records may include at least one feature value; at least one label value associated with the at least one feature value; and at least one bias feature value associated with the at least one feature value.

Training the instance of the support vector machine based inference model may include obtaining, based on the training data and an objective function based in part on the debiasing term and the soft margin, a decision boundary.

The debiasing term may incentivize a uniform distribution of the records with respect to the bias features across the decision boundary in the objective function.

The objective function may include a weight that scales a level of the incentive for the uniform distribution of the records.

In an embodiment, a non-transitory media is provided that may include instructions that when executed by a processor cause the computer implemented method to be performed.

In an embodiment, a data processing system is provided that may include the non-transitory media and a processor and may perform the computer implemented method when the computer instructions are executed by the processor.

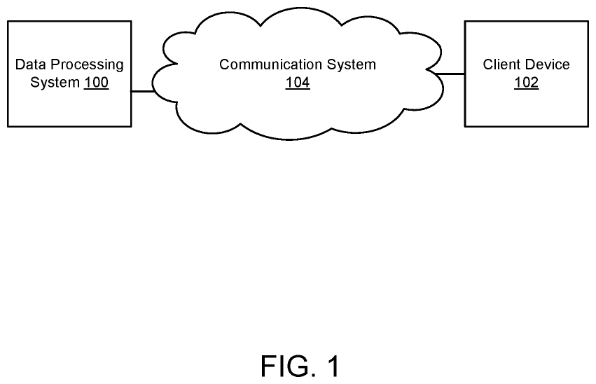

Turning to FIG. 1, a block diagram illustrating a system in accordance with an embodiment is shown. The system shown in FIG. 1 may provide computer implemented services. The computer implemented services may include, for example, database services, instant messaging services, and/or other types of computer implemented services. The computer implemented services may be provided by any number of data processing systems (e.g., 100). The data processing systems may provide similar and/or different computer implemented services. The data processing systems, client device 102, and/or other devices (not shown) may utilize the computer implemented services.

Any of the computer implemented services may be provided using inferences. For example, the inferences may indicate content to be displayed as part of the computer implemented services, how to perform certain actions, and/or may include other types of information used to provide the computer implemented services.

To obtain the inferences, one or more inference models (e.g., hosted by data processing systems and/or other devices operably connected to the data processing systems) may be used. The inference models may, for example, ingest input and output inferences based on the ingested input. The content of the ingest input and output may depend on the goal of the respective inference model, the architecture of the inference model, and/or other factors.

However, if the inferences generated by the inference models do not meet expectations of the consumers (e.g., the computer implemented services) of the inferences, then the computer implemented services may be provided in an undesired manner. For example, the computer implemented services may presume that the inferences generated by the inference models exhibit certain characteristics such as accuracy with respect to predicting certain quantities or trends. If the inferences fail to meet these expectations, then the computer implemented services may be negatively impacted.

The inferences generated by an inference model may be undesirable if the inferences exhibit latent bias. As noted above, to obtain inferences, the inference model may ingest input and provide output. The relationship between ingested input and output used by the inference model may be established based on training data. The training data may include known relationships between input and output. The inference model may attempt to generalize the known relationships between the input and the output.

However, the process of generalization (e.g., training processes) may result in unforeseen outcomes. For example, the generalization process may result in latent bias being introduced into the generalized relationship used by the inference model to provide inferences based on ingest data. Latent bias may be an undesired property of a trained inference model that results in the inference model generating undesirable inferences (e.g., inferences not made as expected by the manager of the inference model). For example, training data may include a correlation that is not obvious but that may result in latent bias being introduced into inference models trained using training data. If consumed by computer implemented services, these undesirable inferences may negatively impact the computer implemented services.

Latent bias may be introduced into inference models based on training data limits and/or other factors. These limits and/or other factors may be based on non-obvious correlations existing in the training data. For example, data processing system 100 may have access to a biased source of data (e.g., a biased person) in which the training data is obtained from. The biased person may be a loan officer working at a financial institution, and the loan officer may have authority to view personal information of clients of the financial institution to determine loan amounts for each of the clients. Assume the loan officer carries discriminatory views against those of a particular ethnicity. The loan officer may make offers of low loan amounts to clients that are of the particular ethnicity, in comparison to clients that are not of the particular ethnicity. When training data is obtained from a biased source, such as the loan officer, the training data may include correlations that exist due to the discriminatory views of the loan officer. This training data may be used when placing an inference model of data processing system 100 in a trained state in order to provide inferences used in the computer implemented services.

Due to these limits and/or other factors, such as biased sources, the training data used to train the inference model may include information that correlates with a bias feature, such as sex (e.g., male and/or female), that is undesired from the perspective of consumers of inferences generated by the inference model. This correlation may be due to the features (input data) used as training data (e.g., income, favorite shopping locations, number of dependents, etc.).

For example, a trained inference model that includes latent bias, when trained to provide inferences used in computer implemented services (to determine a risk an individual has of defaulting on loans) provided by a financial institution, may consistently generate inferences indicating female persons have a high risk of defaulting on loans. This inadvertent bias (i.e., latent bias) may cause undesired discrimination against female persons and/or other undesired outcomes by consumption of the inferences by the financial institution.

In general, embodiments disclosed herein may provide methods, systems, and/or devices for providing computer implemented services. To provide the computer implemented services, inference models may be used to provide inferences used to provide the computer implemented services.

The inference models may include, for example, support vector machines (SVMs) based inference models. The SVM based models may be obtained by (i) obtaining training data, (ii) training a new instance of a SVM based inference model using the training data.

When training new instances of the SVM based models, a training procedure may be used that may improve the likelihood of the resulting trained models providing desired inferences. The training procedure may reduce the likelihood of the trained models exhibiting latent bias.

Latent bias may be exhibited by a trained inference model, for example, when predictions by the model appear to be based on a feature that is not included in features of a training data set. The resulting inferences of a trained inference model that exhibits latent bias may be undesirable.

For example, consider a scenario where a bank wishes to use an inference model to decide on whether and to what extent financial offers are to be made to its clients. To obtain an inference model, a training data set may be established based on past financial offers made to the clients. From the bank's records, the financial offers may appear to only be based on financial and location characteristics (e.g., credit score, income, domicile location, etc.) of its clients. However, the bank's employees that made the decisions may actually have taken into account other characteristics of the clients, such as race, sex, etc., even if unintentionally due to their own personal biases. Consequently, the resulting decisions may, in fact, be based on in part on these other characteristics of the clients.

If the training data that only takes into account the relationships between financial and location characteristics of the clients and the resulting decisions regarding the financial offers, inference models trained using only this training data may exhibit latent bias with respect to these other characteristics (e.g., race, sex, etc.).

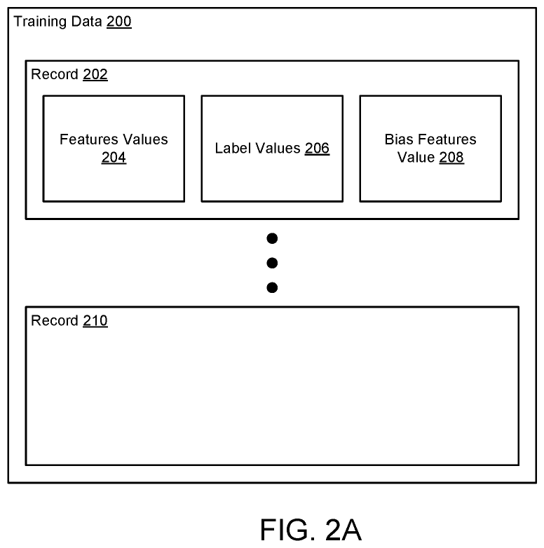

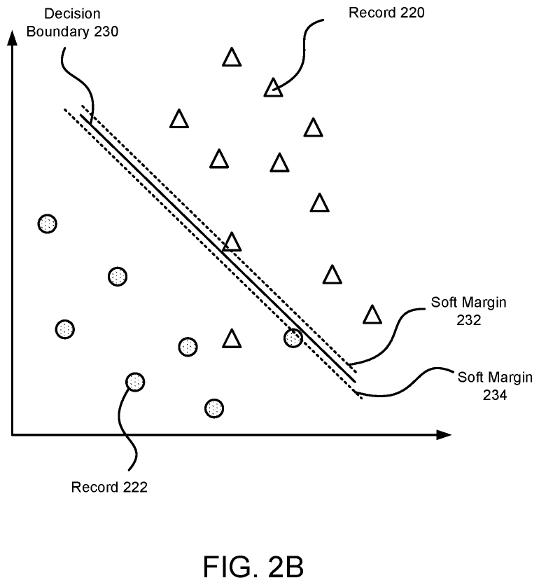

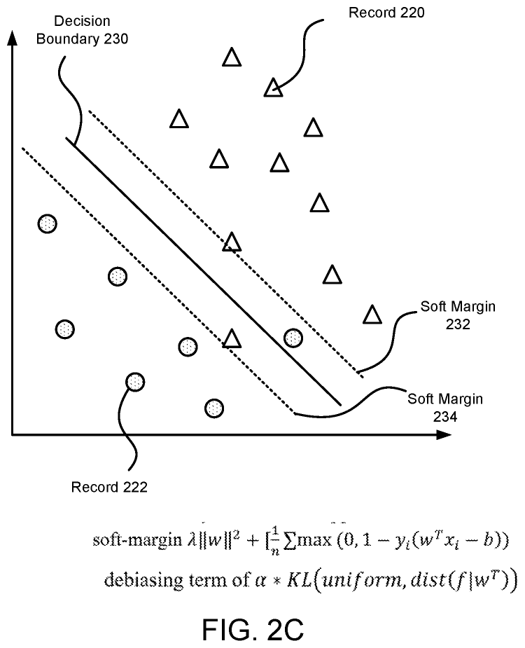

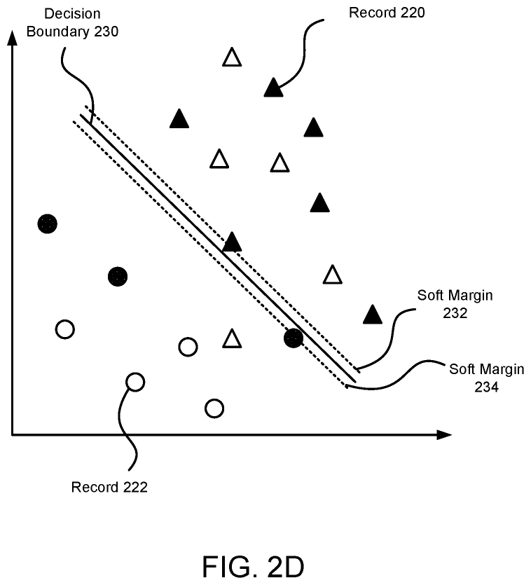

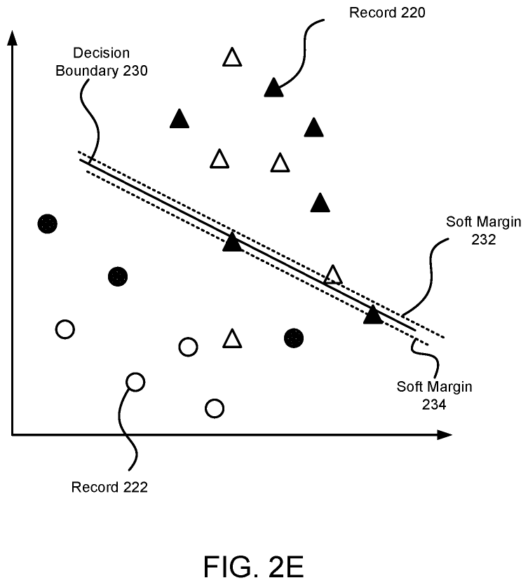

To reduce the likelihood of trained inference models exhibiting latent bias, the training procedure used by the system of FIG. 1 may (i) take into account bias features by establishing training data that reflects the relationships between the features (e.g., financial/location characteristics) and bias features (e.g., race/sex/etc.), and (ii) fits model parameters (e.g., decision boundaries) in trained inference models that provide for high predictive power for labels (e.g., decisions regarding extending financial offers) in the training data and low predictive power for the bias features. To do so, the training procedure may utilize an objective function that is based on a soft margin with respect to the decision boundary and a debiasing term. The debiasing term may incentivize distribution of records from the training data across the decision boundary such that the records on either side of the decision boundary are less likely to predictive of the bias feature. For example, the debiasing term may incentivize uniform distribution of the records with respect to the bias feature across the decision boundary. Refer to FIG. 2A for additional details regarding training data, and FIGS. 2B-2E for additional details regarding SVM based models.

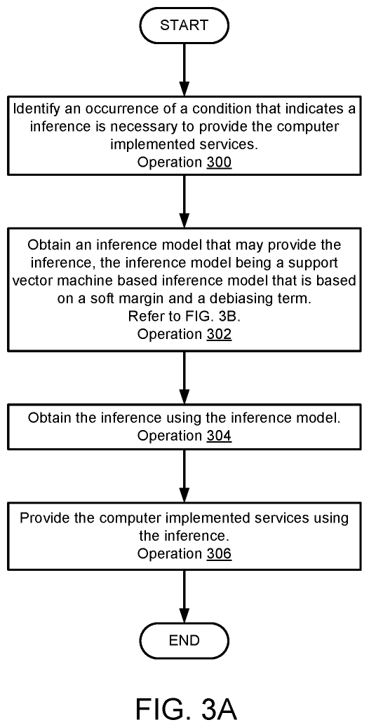

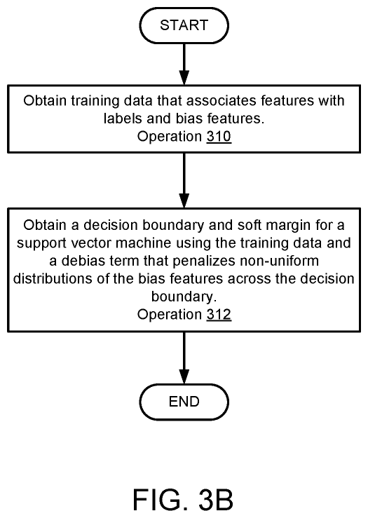

When performing its functionality, client device 102 and/or data processing system 100 may perform all, or a portion, of the methods and/or actions described in FIGS. 2A-3B.

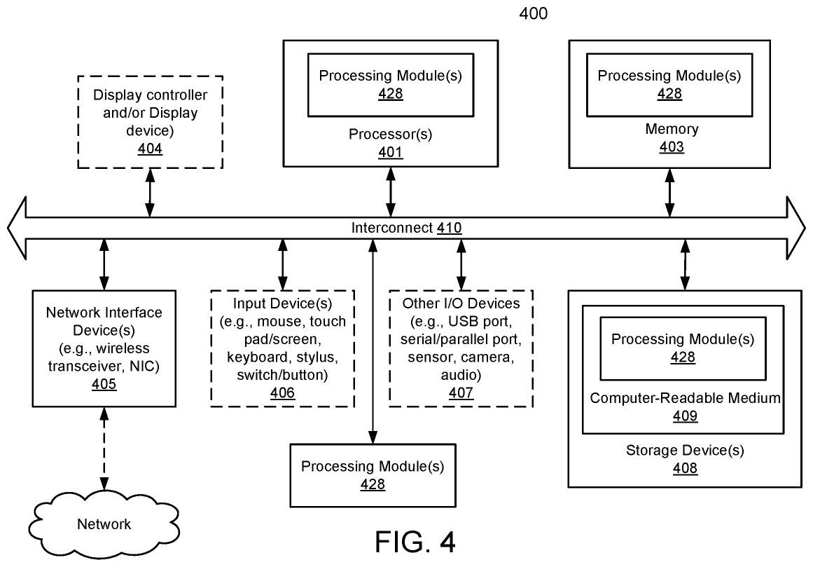

Data processing system 100 and/or client device 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with a communication system 104. In an embodiment, communication system 104 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, a data structure diagram is shown in FIG. 2A and diagrams illustrating the topology of potential decision boundaries for support vector machines are shown in FIGS. 2B-2E. In FIGS. 2B-2C, potential decision boundaries for a SVM in accordance with an embodiment that does not utilize a debiasing term are illustrated. In contrast, in FIGS. 2D-2E, decision boundaries for a SVM in accordance with an embodiment that utilizes a debiasing term are illustrated.

Turning to FIG. 2A, a diagram illustrating training data 200 in accordance with an embodiment is shown. Training data 200 may be used to train an inference model in a manner that is less likely to exhibit latent bias.

Training data 200 may include any number of records 202-210. Each of records 202-210 may include features values 204, label values 206, and bias feature values 208. Each of these portions of the records is discussed below.

To establish training data 200, a set of features may be selected. The features may include any number and types of features. Feature values 204 of each record may reflect the values of the selected features for a particular data point (e.g., a record) in training data 200.

Label values 206 may be the values for labels corresponding to the feature values. Returning to the financial offer decision example, feature values 204 may reflect the characteristics (e.g., credit score, income, etc.) of a single client, and label values 206 reflect the decisions (e.g., whether to extend an offer) made based on feature values 204 in a past transaction. In some embodiments, label values 206 are not included in training data 200. For example, in scenarios in which a SVM is used to perform unsupervised learning the records may not include label values because classifications for the records, with respect to features, may not be known.

Bias feature values 208 may be the values for the bias features corresponding to the feature values. Returning to the financial offer decision example, feature values 204 may reflect the characteristics (e.g., credit score, income, etc.) of a single client, and bias feature values 208 reflect the other characteristics (e.g., sex) of the client.

Training data 200 may include any number of records, and may be implemented using any number of data structures. For example, training data 200 may be implemented using a database, a linked list, a table, and/or other types of data structures.

Turning to FIG. 2B, a diagram illustrating an instance of a SVM based model in accordance with an embodiment is shown. The SVM based model may be obtained, for example, using training data 200. The SVM based model may provide inferences, and may do so without use of a debiasing term.

The SVM based model may include decision boundary 230. The decision boundary may define different classifications for data. In FIG. 2B, the decision boundary is illustrated as a line on a two dimensional space. It will be appreciated that the decision boundary may be a higher dimensional entity thereby facilitating classification of multidimensional data.

Decision boundary 230 may be based on the training data by attempting to establish a line (or higher dimensional entity) that divides the records of the training data into groups corresponding to the labels of the training data (or general classifications if used for unsupervised learning). For example, in FIG. 2B, records (e.g., 220, 222) are illustrated using different shapes corresponding to different labels.

To obtain decision boundary 230, an optimization process may be performed that attempts to (i) divide the records into groups that classify the records based on the labels, and (ii) maximize a margin between decision boundary 230 and the nearest records. However, this may not always be possible even for decision boundaries having complex shapes. For example, some of the records associated with different labels may be intermixed (e.g., not linearly separable).

To establish decision boundary 230, a soft margin may be utilized. The soft margin may allow for some of the records to be misclassified (e.g., such as the triangle to the left of decision boundary in FIG. 2B) by the decision boundary 230, while still attempting to maximize the margin between decision boundary 230 and the other records of the respective classifications.

To do so, an objective function may be utilized that weighs the advantages of a larger margin against the disadvantages of misclassification.

It will be appreciated that the soft margin may only be a mathematic construct. In FIGS. 2B-2E, representations of the soft margins are only included for illustrative purposes. In practice, the size of the soft margin (e.g., width extending from the decision boundary) may be a term which is optimized for when deciding on the parameters that define the decision boundary.

Turning to FIG. 2C, a second diagram illustrating an instance of a SVM based model in accordance with an embodiment is shown. The SVM based model shown in FIG. 2C may be further optimized when compared to the SVM based model shown in FIG. 2C. Any optimization technique may be utilized (e.g., gradient descent, evolution based optimization, etc.) to perform the optimization.

As seen in FIG. 2C, decision boundary 230 has been shifted to the left when compared to FIG. 2B. The optimization process may do so, for example, due to higher levels of penalization for records that are both misclassified by decision boundary 230, but are also outside of a soft margin (e.g., 232, 234) used in the optimization process. As seen in FIG. 2C, the left most triangle is now within soft margin 234 thereby reducing the level of penalization when compared to FIG. 2B.

During the optimization, decision boundary may be optimized under the first constraint (e.g., the soft-margin) shown in FIG. 2C which may (i) reward increases in size of the soft margin, (ii) penalize misclassification at a first level, and (iii) penalize misclassifications that also fall outside of the soft margin at a second level that is higher than the first level.

However, optimizing decision boundary 230 only based on the first constraint may result in latent bias being exhibited. To reduce the likelihood of latent bias being exhibited, decision boundary 230 and soft margin (e.g., 232, 234) may also optimized using a debiasing term (e.g., shown in FIG. 2C). The debiasing term may reward the extent to which the records classified into different groups by decision boundary 230 uniformly distribute records such that the bias features are also not classified.

For example, if the bias feature is whether a client is of the female sex, then the debiasing feature may reward distributions of the record that place equal numbers of the records indicating that the sex is female on either side of decision boundary 230.

To do so, the debiasing term may weight (e.g., using a constant) the Kullback-Leibler (KL) divergence of the distribution of the bias feature across the decision boundary with respect to a uniform distribution of vectors from the records to decision boundary 230 (e.g., w^{t}). A mathematic description of the debiasing term is shown in FIG. 2C. By doing so, a weighted value corresponding to how well the records for each bias feature value are distributed across decision boundary 230 may be obtained. When added to the constraint, the resulting value may provide a numerical value that balances how well decision boundary 230 classifies the records with respect to the labels against how well decision boundary 230 classifies the records with respect to the bias feature. Thus, the objective function, when optimized, may provide a decision boundary having high classification ability with respect to the labels and low classification value with respect to the bias features.

For example, turning to FIG. 2D, a third diagram illustrating an instance of a SVM based model in accordance with an embodiment is shown. The third diagram may be identical to the diagram shown in FIG. 2B (e.g., prior to optimization), except for each of the records being colored according to a classification for a bias feature of the records.

As seen in FIG. 2D, the records to the bottom left and top right of the boundary may include a non-uniform distribution of each classification. For example, in the bottom left, the classification associated with the white coloring (e.g., record 222) may be overrepresented. In contrast, to the right and above decision boundary 230, the classification associated with the black coloring (e.g., record 220) may be overrepresented.

During optimization of decision boundary 230, the debiasing term may penalize this distribution and other distributions that diverge from a uniform distribution of each classification across the boundary. For example, the objective function may deduct from the score for this location of decision boundary 230 due to the distribution.

Turning to FIG. 2E, a fourth diagram illustrating an instance of a SVM based model in accordance with an embodiment is shown. The fourth diagram may show decision boundary 230 after optimization. As seen in FIG. 2E, the records to the bottom left and top right of decision boundary 230 may include a more uniform distribution of each classification. For example, the classifications associated with each color may be equal in number.

Thus, through optimization using the debiasing term, the resulting decision boundary placement may divide the records into two groups that are not predictive for the bias feature (e.g., would be predictive if most of the records on each side of the decision boundary were of one classification or the other classification).

As discussed above, the components and/or data structures of FIG. 1 may perform various methods to provide computer implemented services using inference models that are less likely to exhibit latent bias. FIGS. 3A-3B illustrate methods that may be performed by the components of FIG. 1. In the diagrams discussed below and shown in these figures, any of the operations may be repeated, performed in different orders, omitted, and/or performed in a parallel or a partially overlapping in time manner with other operations.

Turning to FIG. 3A, a flow diagram illustrating a method of providing computer implanted services in accordance with an embodiment is shown. The method may be performed, for example, by a data processing system, a client device, a communication system, and/or other components and/or data structures illustrated in FIGS. 1-2B.

At operation 300, an occurrence of a condition that indicates that an inference is necessary to provide the computer implemented services. The occurrence may be, for example, a request for a new inference. The occurrence may be other types of conditions encountered by a data processing system.

At operation 302, an inference model is obtained. The inference model may be a SVM based inference model. The SVM based model may be based on a soft margin and a debiasing term. The soft margin and debiasing term may be used to select a decision boundary used to classify records and/or new data.

The soft margin may allow a decision boundary for the SVM to be established that allows for some misclassification. The misclassification may be balanced against increased size of the margin between the decision boundary and other records of training data.

The debiasing term may incentivize a distribution of records of the training data such that the decision boundary poorly classifies the records with respect to bias features. The debiasing term may be weighted projection of the distribution of the records on a distribution of the records for different bias feature classifications uniformly across the decision boundary. For example, the KL distribution may be utilized to obtain a weighted scalar value. The weighting of the scalar value may be set to more aggressively or less aggressively disincentivize latent bias in the classifications provided by the decision boundary of the inference model.

The inference model may be obtained by (i) reading it (e.g., if it already exists) from storage (into memory, or it already may be in memory), or (ii) generating the inference model (if it does not exist).

In an embodiment, the inference model is generated using the method illustrated in FIG. 3B.

At operation 304, an inference is obtained using the inference model. The inference may be obtained by ingesting data into the inference model, or using a now-classified portion of the training data. The data may correspond to a set of feature values for features of the training data. The inference model may generate the inference as output.

As discussed with respect to FIG. 2B, the inference may be generated by identifying on which side of the decision boundary a record or data point is located. The decision boundary may delineate different classifications.

At operation 306, the computer implemented services are provided using the inference. The computer implemented services may be provided using the inference, for example, by performing one or more actions based on the inference.

The method may end following operation 306.

Turning to FIG. 3B, a flow diagram illustrating a method of obtaining an inference model in accordance with an embodiment is shown. The method may be performed, for example, by a data processing system, a client device, a communication system, and/or other components and/or data structures illustrated in FIGS. 1-2C.

At operation 310, training data that associated features with labels and bias features is obtained. The training data may be similar to that described with respect to FIG. 2A. The training data may be obtained by reading it from storage, generating it, receiving it from another device, or via other means.

At operation 312, a decision boundary and a soft margin for a SVM based inference model is obtained using the training data and a debiasing term. The debiasing term, as discussed above, may penalize non-uniform distributions of the bias features across the decision boundary.

The decision boundary and soft margin may be obtained by (i) obtaining an objective function using a constraint reflecting the soft margin and the debiasing term. The form of the decision boundary and soft margin may then be obtained through optimization of the objective function. Any optimization process may be utilized.

The method may end following operation 312.

Any of the components illustrated in FIG. 1 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer implemented services using inference models, the method comprising:
identifying an occurrence of a condition that indicates an inference is necessary to provide the computer implemented services;
based on the occurrence:
obtaining an inference model of the inference models, the inference model being a support vector machine based inference model that is based on a soft margin and a debiasing term;
obtaining the inference using the inference model; and
providing the computer implemented services using the inference.

2. The method of claim 1, wherein obtaining the inference model comprises:
reading the inference model from storage.

3. The method of claim 1, wherein obtaining the inference model comprises:
prior to identifying the occurrence:
training an instance of the support vector machine based inference model using training data.

4. The method of claim 3, wherein the training data comprises:
records, and each of the records comprises:
at least one feature value;
at least one label value associated with the at least one feature value; and
at least one bias feature value associated with the at least one feature value.

5. The method of claim 4, wherein training the instance of the support vector machine based inference model comprises:
obtaining, based on the training data and an objective function based in part on the debiasing term and the soft margin, a decision boundary.

6. The method of claim 5, wherein the debiasing term incentivizes a uniform distribution of the records with respect to the bias features across the decision boundary in the objective function.

7. The method of claim 6, wherein the objective function comprises a weight that scales a level of the incentive for the uniform distribution of the records.

8. A non-transitory machine-readable medium having instructions stored therein, which when executed by a processor, cause the processor to perform operations for providing computer implemented services using inference models, the operations comprising:
identifying an occurrence of a condition that indicates an inference is necessary to provide the computer implemented services;
based on the occurrence:
obtaining an inference model of the inference models, the inference model being a support vector machine based inference model that is based on a soft margin and a debiasing term;
obtaining the inference using the inference model; and
providing the computer implemented services using the inference.

9. The non-transitory machine-readable medium of claim 8, wherein obtaining the inference model comprises:
reading the inference model from storage.

10. The non-transitory machine-readable medium of claim 8, wherein obtaining the inference model comprises:
prior to identifying the occurrence:
training an instance of the support vector machine based inference model using a training data.

11. The non-transitory machine-readable medium of claim 10, wherein the training data comprises:
records, and each of the records comprises:
at least one feature value;
at least one label value associated with the at least one feature value; and
at least one bias feature value associated with the at least one feature value.

12. The non-transitory machine-readable medium of claim 11, wherein training the instance of the support vector machine based inference model comprises:
obtaining, based on the training data and an objective function based in part on the debiasing term and the soft margin, a decision boundary.

13. The non-transitory machine-readable medium of claim 12, wherein the debiasing term incentivizes a uniform distribution of the records with respect to the bias features across the decision boundary in the objective function.

14. The non-transitory machine-readable medium of claim 13, wherein the objective function comprises a weight that scales a level of the incentive for the uniform distribution of the records.

15. A data processing system, comprising:
a processor; and
a memory coupled to the processor to store instructions, which when executed by the processor, cause the processor to perform operations for providing computer implemented services using inference models, the operations comprising:
identifying an occurrence of a condition that indicates an inference is necessary to provide the computer implemented services;
based on the occurrence:
obtaining an inference model of the inference models, the inference model being a support vector machine based inference model that is based on a soft margin and a debiasing term;
obtaining the inference using the inference model; and
providing the computer implemented services using the inference.

16. The data processing system of claim 15, wherein obtaining the inference model comprises:
prior to identifying the occurrence:
training an instance of the support vector machine based inference model using a training data.

17. The data processing system of claim 16, wherein the training data comprises:
records, and each of the records comprises:
at least one feature value;
at least one label value associated with the at least one feature value; and
at least one bias feature value associated with the at least one feature value.

18. The data processing system of claim 17, wherein training the instance of the support vector machine based inference model comprises:
obtaining, based on the training data and an objective function based in part on the debiasing term and the soft margin, a decision boundary.

19. The data processing system of claim 18, wherein the debiasing term incentivizes a uniform distribution of the records with respect to the bias features across the decision boundary in the objective function.

20. The data processing system of claim 19, wherein the objective function comprises a weight that scales a level of the incentive for the uniform distribution of the records.
